(19) United States
(12) Patent Application Publication
(10) Pub. No.: US 2004/0201138 A1
(43) Pub. Date: Oct. 14, 2004

(54) Mother plate for deep lines pattern impression and manufacturing thereof

(75) Inventors: Hsing-Mao Wang, Hsinchu (TW); Min-Yi Hsu, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 10/411,238

(22) Filed: Apr. 11, 2003

(51) Int. Cl. B29C 33/40

(52) U.S. Cl. 264/496; 156/60; 264/219; 425/175

(57) ABSTRACT

The UV resin used in the present invention is spread on the surface of a mother mold with lines. Illuminate UV light to harden the UV resin after it penetrated the lines completely. Thereby, to the depth and the shape of the lines of a pattern with deep lines, a complete duplication can be obtained in order to solve the deficiency of mother plate manufacturing technique at present. A seam between two mother plates is more smooth and has less influence on the lines structures at two sides thereof when a plurality of mother plate units are assembled to a big mother plate. The present invention provides an easy and novel plates assembly technique that gives consideration to both the lines in succeeding electroplating and impression procedures and required flatness for seams. Thereby, a seam between two mother plates is more smooth and has less influence on the lines structures at two sides thereof when a plurality of mother plate units are assembled to a big mother plate.

### BACKGROUND OF THE INVENTION

1. Field of the Invention

The present invention relates to an impression mother plate for manufacturing deep lines pattern or holographic pattern, and more particularly to manufacturing and plates assembly techniques for an impression mother plate and impression mother plate for manufacturing deep lines pattern or holographic pattern.

2. Description of Related Art

One of the techniques for manufacturing a holographic pattern impression mother plate using a holographic pattern lines impression process is Taiwan patent No. 384,419. The manufacturing process disclosed in the patent is: using an optical grating from computer drafting to fabricate a mask; and then using a semiconductor manufacturing process to manufacturing a holographic plate, and electroforming it to be a nickel plate; finally, duplicating the nickel plate to from a holographic finished product of a plastic material. The mother plate made by the semiconductor manufacturing mentioned above wastes time and costs much.

Please refer to FIG. 1. FIG. 1 shows another cheaper and simpler mother plate manufacturing method. The method has the steps as the following: sticking a plastic plate 10 with a mother mold 20 engraved with a holographic pattern lines 21; heating and pressing the plastic plate 10 in order to deform it owing to the effect of temperature and pressure. Thereafter, lines 11 corresponding to the lines 21 on the mother mold 20 will be generated on the face of the plastic plate 10 that is stuck with the mother mold 20. Therefore, the duplication of the holographic pattern lines is completed and a mother plate used for impression is finished.

However, using such kind of process to manufacture a mother plate might cause the shape and the depth of the lines 21 to change and is easy to bring about the incompleteness of the duplication of the lines 21. The main reason is that the duplication effect is restricted by the deformation limit of the plastic material of the plastic plate 10 under heat and pressure when the lines of a holographic pattern is duplicated by means of heat and pressure exertion. At present, the lines of a holographic pattern are always under 1 μm (micrometer); the lines duplicated by means of heat and pressure exertion might cause a part of the lines to be shallow after the duplication is completed and further might cause the loss on illumination and color of a holographic pattern. But, deeper lines are needed when a better optical refraction effect is required. The mother plate manufacturing mentioned above couldn't duplicate a pattern of deeper lines on a mother plate when the depth of lines is increased to several μm or even more.

### SUMMARY OF THE INVENTION

For providing a mother plate that is applicable on a pattern with lines of several ten μm and meets the requirement of succeeding impression procedures, the present invention is proposed.

The main object of the present invention is to provide a mother plate for a deep lines pattern impression and the manufacturing thereof, enabling the lines of a holographic pattern to be duplicated completely on the mother plate.

Another object of the present invention is to provide a mother plate for a deep lines pattern impression and the manufacturing thereof, a seam between two mother plates is more smooth and has less influence on the lines structures at two sides thereof when a plurality of mother plate units are assembled to a big mother plate.

### BRIEF DESCRIPTION OF THE DRAWINGS

The present invention can be more fully understood by reference to the following description and accompanying drawings, in which:

FIG. 1 is a schematic view, showing manufacturing of a conventional mother plate unit;

FIGS. 2A and 2B are schematic views, showing manufacturing of a mother plate unit of a preferred embodiment according to the present invention;

FIGS. 3A, 3B and 3C are schematic views, showing a plates assembly of a preferred embodiment according to the present invention;

FIGS. 4A and 4B are schematic views, showing an assembly of mother plate units of another preferred embodiment according to the present invention.

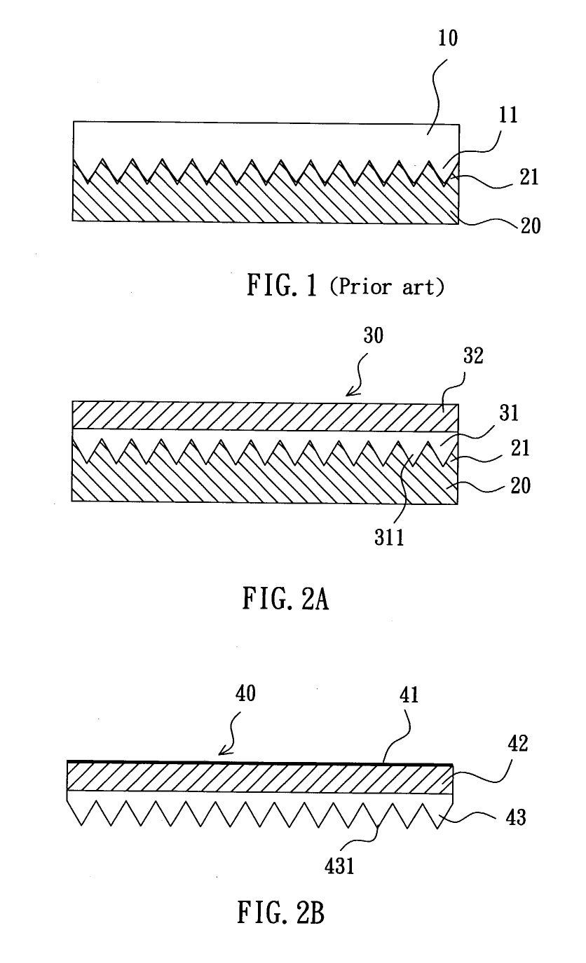

### DETAILED DESCRIPTION OF THE PREFERRED EMBODIMENTS

Please refer to FIG. 2A and FIG. 2B. A layer of sensitization type UV resin 31 is spread on the surface of a mother mold 20 with lines 21, and then, a transparent plate 32, which made from PC, PVC or others, is covered on the UV resin 31. Corresponding lines 311 are formed on the UV resin 31 after the UV resin permeates into the lines 21 completely. Thereafter, UV light is illuminated on and to harden the UV resin 31 so that the UV resin 31 is stuck on the transparent plate 32. Finally, the UV resin 31 is separated from the mother mold 20 and consequently the lines 21 of the mother mold 20 are completely duplicated on the UV resin 31. These steps are repeated several times to obtain a number of mother plate units 30 with the deep lines 311.

Taking the mother plate unit 30 with the lines 311 as a mother mold to duplicate the lines 311 onto a UV resin 43 that is in front of a transparent plate 42 whose backside is plated with a metal film such as an aluminum film 41 so as to obtain corresponding lines 431. Therefore, a mother plate unit 40 whose backside is plated with the aluminum film 41 is finished.

A plates assembly method according to the present invention is to use a seam filling and sticking manufacturing process to assemble the mother plate units 40 to be a complete mother plate or to increase total size of the mother plate unit 40.

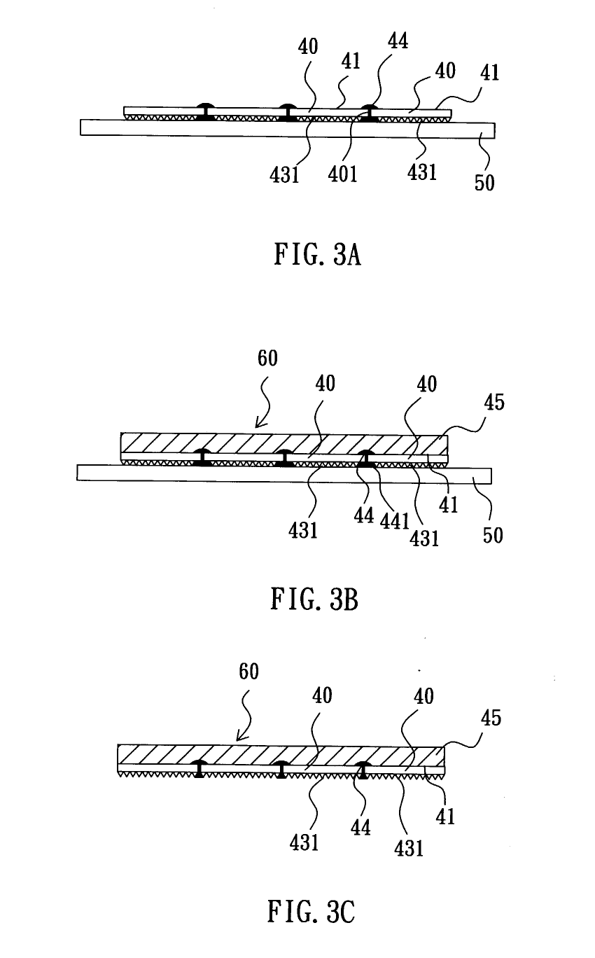

Please refer to FIG. 3A. a plates assembly method of a preferred embodiment according to the present invention is to take a plane silicone 50 as a base plate. And then, place the mother plate units 40 whose backside plated with aluminum film one by one on the silicone 50 by facing the face with the lines 431 down to stick on the surface of the silicone 50. Thereafter, use a UV resin 44 as a filling agent to spread it on seams 401 of the mother plate units 40; the V resin 44 will fill the seams 401 by gravity force and a part of it will penetrate to the surface of the lines 431. After the UV resin 44 is spread, UV light is illuminated to affect the UV resin 44 on the mother plate units and in the seams 401 to be solidified so as to combine the mother plate units into a big mother plate. But, the UV resin penetrating on the surface of the lines 431 cannot be solidified in the middle of the UV illumination, because it is shielded by the aluminum film 41 from the UV illumination. Therefore, the unhardened UV resin can be erased by a solvent such as alcohol in order to prevent the structure of the lines from damaging.

Please refer to FIGS. 3B and 3C, after the seam filling and the plates assembly is completed, epoxy resin 45 can be spread onto the aluminum film 41 to strengthen the whole mother plate. The whole mother plate 60 with deep lines can be taken down from the silicone 50 after the epoxy resin is hardened. Thereafter, the unhardened UV resin 441 on the surface of the lines 431 is cleaned to complete the whole plates assembly process.

The mother plate unit stuck on the silicone 50 is not easy to be moved during the whole process owing to the viscosity possessed in the silicone 50 itself. The mother plate units 40 after combined to be a big mother plate 60 are smooth enough to meet the requirement of the succeeding electroplating and impression procedures owing to the smooth surface of the silicone 50. And, the mother plate units 40 can be arranged close enough one by one in order to allow the width of the each seam 401 to maintain only several ten μm so that the whole plate face can be more complete and artistic.

A plates assembly method of another preferred embodiment according to the present invention is using the technology of the plates assembly through epoxy resin filling.

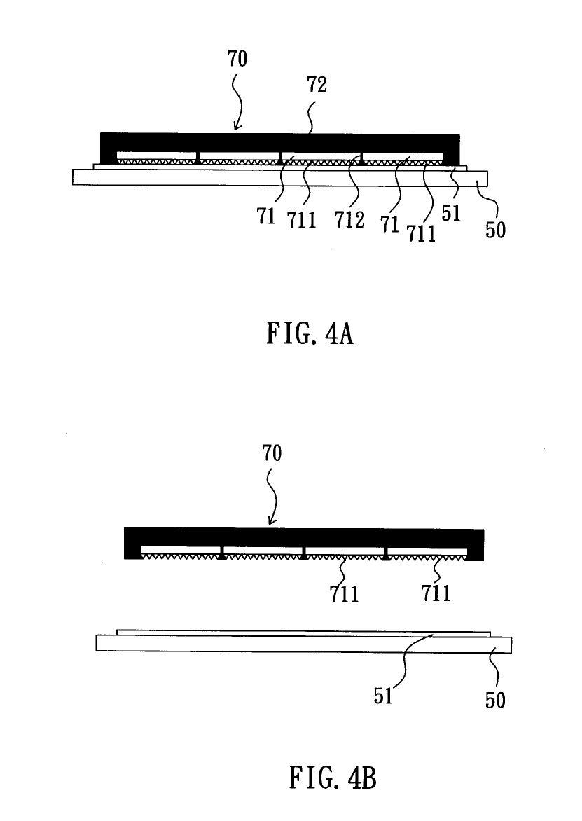

Please refer to FIGS. 4A and 4B. First, prepare a sheet of smooth silicone 50 as a base plate, and then, stick a layer of twin adhesive tape 51 on the silicone 50. Again, stick each mother plate unit 71 on the tape 51 by facing lines 711 down. Thereafter, spread uniformly a layer of epoxy resin 72 on the backside of each mother plate unit 71 to a required thickness; the epoxy resin 72 will then fill into seams 712 by gravity and is stopped on the surface of the tape 51. The seam filling epoxy 72 will not penetrate the surface of the lines 711 owing to the tight sticking between the lines 711 and the tape 51. The tape 51 and a big mother plate 70 can be separated from each other directly after the epoxy resin 72 is hardened. The mother plate unit 30 shown in FIG. 2A can be used for the mother plate unit 71 in this preferred embodiment.

The epoxy resin 72 of this preferred embodiment is used as a material for seam filling and plates assembly, a layer of epoxy resin 72 is spread uniformly on the backside of each mother plate unit 71 to a required thickness. The twin adhesive tape 51 possesses proper viscosity to form a stop layer to stop the epoxy resin 72 to penetrate into the surface of the lines 711 during the whole seam filling process. Each mother plate unit 71 stuck on the surface of the tape 51 can not be moved easily owing to the viscosity of the tape during the whole process. The face of the mother plate 70 can meet the requirement of entirety smoothness after the plates assembly is completed through the smooth surface of the silicone 50 so as to meet the requirement of the succeeding electroplating and impression procedures. And, the mother plate units 71 can be arranged close enough one by one in order to allow the width of the each seam 712 to maintain only several ten μm so that the whole plate face can be more complete and artistic.

The UV resin used in the present invention is spread on the surface of a mother mold with lines. Illuminate UV light to harden the UV resin after it penetrated the lines completely. Thereby, to the depth and the shape of the lines of a pattern with deep lines, a complete duplication can be obtained. But, that temperature and pressure are used to cause plastics to yield a deformation so as to reproduce lines in the convention manufacturing method is limited by the deformation limit, so that the lines on the mother mold are unable to be reproduced on the mother plate. The manufacturing method of a plate unit according to the present invention improved more obviously than the conventional manufacturing method. Lines whose depth is below 1 μm to several ten μm can be reproduced more perfectly. The deeper is the depth of lines; the better is the method according to the present invention compared to the conventional method in that pressure and temperature is utilized to deform plastics to reproduce lines.

The present invention not only can solve the problems of deep lines duplication, but also provide an easy and novel plates assembly technique that gives consideration to both the lines in succeeding electroplating and impression procedures and required flatness for seams. Therefore, the way according to the present invention in handling the width of seam and influence to the lines at the two sides thereof during plates assembly is better than the one used in the conventional method, and fills the bill in the flatness of a mother plate in succeeding electroplating and impression procedures.

It is noted that the mother plate for a deep lines pattern impression and the manufacturing thereof described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

What is claimed is:

1. A manufacturing method for a impression mother plate with pattern lines, mainly comprising the following steps:
(1) spreading UV resin on the surface of a mother mold with lines;
(2) covering a transparent plate on said UV resin, and forming corresponding lines on said UV resin after said UV resin penetrates the lines of said mother mold completely;
(3) illuminating UV light on said UV resin to solidified said UV resin so as to attach said UV resin on said transparent plate; and
(4) separating said UV resin from said mother mold when the lines of said mother mold are completely reproduced on said UV resin.

2. The method according to claim 1, wherein said transparent is made from PC or PVC.

3. The method according to claim 2, wherein said transparent is plated with a metal film on the backside thereof.

4. The method according to claim 3, wherein said metal film is an aluminum film.

5. a method for assembling impression mother plates with pattern lines, comprising the follow steps:
(1) sticking at least two mother plate units whose backsides are plated with metal films respectively on the surface of a silicone base plate by facing said lines down;
(2) spreading UV resin on seams of said mother plate units, wherein said UV resin fills in said seams, and a part thereof penetrates into the surface of said lines;
(3) illuminating UV light to solidify said UV resin on said mother plate units and in said seams to assemble all said mother plate units into a big mother plate;
(4) separating said mother plate from said silicone base plate; and
(5) erasing said unhardened UV resin from said surface of said lines.

6. The method according to claim 5, wherein a step is further included between said steps (3) and (4):
Spreading epoxy on the metal film of each said mother plate unit and waiting until said epoxy is hardened.

7. The method according to claim 6, wherein said mother plate unit is made by said manufacturing method for an impression mother plate with pattern lines according to claim 3.

8. A method for assembling impression mother plates with pattern lines, comprising the follow steps:
(1) sticking a layer of twin adhesive tape on a silicone base plate;
(2) sticking at least two sheers of mother plate units on the surface of said twin adhesive tape by facing lines down;
(3) spreading epoxy uniformly on the backside of each said mother plate unit, wherein said epoxy is filled in seams of said mother plate units and is stopped on the surface of said tape, all said mother plate units are assembled into a big mother plate until said epoxy is hardened;
(4) separating said twin adhesive tape from said mother plate.

9. The method according to claim 8, wherein said mother plate unit is made by said manufacturing method for an impression mother plate with pattern lines according to claim 2.

10. An impression mother plate with pattern lines, comprising at least one sheet of mother plate unit, said mother plate comprising a transparent plate combined with a UV resin film, wherein said UV resin film has pattern lines.

11. The mother plate according to claim 10, wherein said mother plate is assembled by at least two sheets of mother plate units; epoxy resin fills between said mother plate units to combine said mother plate units together.

12. The mother plate according to claim 10, wherein said mother plate is assembled by at least two sheets of mother plate units whose backsides are plated with metal films respectively; UV resin fills between said mother plate units to combine said mother plate units together.

13. The mother plate according to claim 11, wherein the backsides of said mother plate units is combined with a layer of epoxy resin.

14. The mother plate according to claim 12, wherein the backsides of said mother plate units is combined with a layer of epoxy resin.
